(19) United States
(12) Patent Application Publication
(10) Pub. No.: US 2017/0293432 A1
(43) Pub. Date: Oct. 12, 2017

(54) MEMORY MANAGEMENT WITH REDUCED FRAGMENTATION

(71) Applicants: David Oldcorn, Harvest Cresent (GB); Timour T. Paltashev, Sunnyvale, CA (US)

(72) Inventors: David Oldcorn, Harvest Cresent (GB); Timour T. Paltashev, Sunnyvale, CA (US)

(21) Appl. No.: 15/094,171

(22) Filed: Apr. 8, 2016

(51) Int. Cl. G06F 3/06; G06F 12/10

(52) U.S. Cl. CPC G06F 3/0605; G06F 3/0608; G06F 3/0631; G06F 3/064; G06F 3/0665; G06F 3/0673; G06F 12/10; G06F 2212/1044; G06F 2212/152; G06F 2212/656; G06F 2212/657

(57) ABSTRACT

Various memory management apparatus and methods are disclosed. In one aspect, a method of memory management is provided that includes receiving a data block in a virtual space, sub-dividing the data block into plural sub-blocks of the same size, and mapping the plural sub-blocks to a physical space according to a selected memory mapping efficiency mode.

### BACKGROUND OF THE INVENTION

### 1. Field of the Invention

This invention relates generally to memory management, and more particularly to methods and apparatus for managing memory of a computing device.

### 2. Description of the Related Art

In computing, virtual memory is a memory management technique that is implemented using both hardware and software. Virtual memory maps memory addresses used by a program, called virtual addresses, into physical addresses in computer memory. Main storage as seen by a process or task appears as a contiguous address space or collection of contiguous segments. A computer operating system manages virtual address spaces and the assignment of real memory to virtual memory. Address translation hardware in the central processing unit (CPU) of the computer, often referred to as a memory management unit or MMU, automatically translates virtual addresses to physical addresses. Software within the operating system may extend these capabilities to provide a virtual address space that can exceed the capacity of real memory and thus reference more memory than is physically present in the computer. The primary benefits of virtual memory include freeing applications from having to manage a shared memory space, increased security due to memory isolation, and being able to conceptually use more memory than might be physically available, using the technique of paging.

Conventional physical spaces may include several different types of memory, each with differing capabilities or efficiencies. Examples include on-chip cache, off-chip dynamic random access memory (DRAM), video random access memory (VRAM) and static random access memory (SRAM).

Conventional memory management techniques may allocate physical memory in contiguous blocks only. Subsequent deallocation of these blocks leads to memory fragmentation. Memory fragmentation can result in high-value allocations ending up in the wrong type of memory, i.e., the lesser or least efficient memory locations of the physical space. Memory fragmentation can also break the spatial locality of data and cause excessive system memory and hard drive reads/writes (page files). Conventional memory management techniques also typically allocate only one memory type at a time for a block.

The present invention is directed to overcoming or reducing the effects of one or more of the foregoing disadvantages.

### SUMMARY OF THE INVENTION

In accordance with one aspect of the present invention, a method of memory management is provided that includes receiving a data block in a virtual space, sub-dividing the data block into plural sub-blocks of the same size, and mapping the plural sub-blocks to a physical space according to a selected memory mapping efficiency mode.

In accordance with another aspect of the present invention, a method of operating a computing device is provided that includes receiving a data block in a virtual space of a processor memory manager, sub-dividing the data block into plural sub-blocks of the same size with the memory manager, and mapping the plural sub-blocks to a physical space with the memory manager. The physical space includes a first memory and a second memory. The mapping according to a selected memory mapping efficiency mode.

In accordance with another aspect of the present invention, a computing device is provided that includes a memory manager and a physical space that has a first memory and a second memory. The memory manager includes a virtual space and is operable to receive a data block in a virtual space of a processor memory manager, sub-divide the data block into plural sub-blocks of the same size, and map the plural sub-blocks to the physical space according to a selected memory mapping efficiency mode.

### BRIEF DESCRIPTION OF THE DRAWINGS

The foregoing and other advantages of the invention will become apparent upon reading the following detailed description and upon reference to the drawings in which:

FIG. 1 is a schematic view of an exemplary embodiment of a computing device that may include a processor and one or more memories;

FIG. 2 is a schematic view of an exemplary embodiment of a memory manager;

FIG. 3 is a schematic view depicting exemplary memory management for an exemplary data block;

FIG. 4 is a schematic view depicting exemplary data block mapping to a physical space;

FIG. 5 is a schematic view depicting exemplary data block mapping for an alternate exemplary physical space;

FIG. 6 is a schematic view like FIG. 5, but depicting deallocation of a sub-block from a physical space;

FIG. 7 is a schematic view like FIG. 6, but depicting re-mapping of a sub-block in a physical space;

FIG. 8 is a schematic view of an exemplary video frame;

FIG. 9 is a flow chart depicting an exemplary memory management method;

FIG. 10 is a flow chart depicting additional aspects of an exemplary memory management method; and

FIG. 11 is a schematic view depicting an exemplary conventional memory management technique.

### DETAILED DESCRIPTION OF SPECIFIC EMBODIMENTS

Various methods of memory management are disclosed. One embodiment utilizes a memory manager in a computing device to take an incoming data block into virtual space, sub-divide the data block into some number of sub-blocks of a standard size and then map or allocate those sub-blocks to physical memory (physical space). The physical memory may consist of different types of memory and at different locations. The virtual addressing capabilities of the memory manager enable the sub-blocks to be mapped to different memory types and locations and, if desired, in non-contiguous regions of the physical space. Mapping may be based on manually or automatically selected efficiency modes. Furthermore, sub-blocks may be mapped based on computational intensity and re-mapped on a dynamic basis in an effort to keep high value allocations mapped to more or most efficient portions of the physical space. Additional details will now be described.

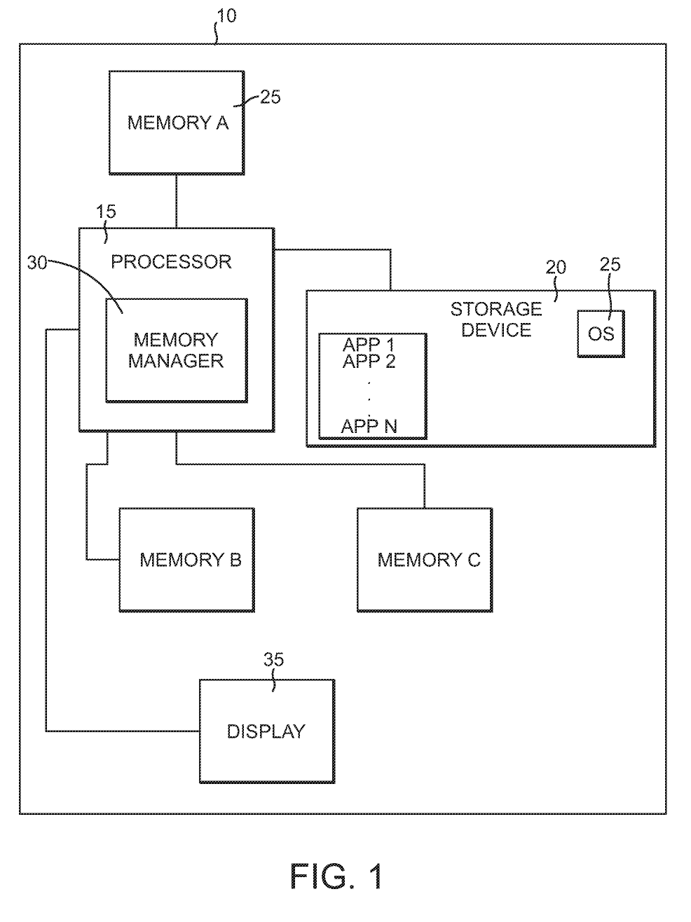

In the drawings described below, reference numerals are generally repeated where identical elements appear in more than one figure. Turning now to the drawings, and in particular to FIG. 1 which is a schematic view of an exemplary embodiment of a computing device 10 that may include a processor 15 and one or more memories Memory A, Memory B and Memory C. The processor 15 may be a microprocessor (CPU), a graphics processor (GPU), a combined microprocessor/graphics processor (APU), an application specification integrated circuit or other type of integrated circuit. The memories Memory A, Memory B and Memory C may number more or less than three and be of a variety of configurations. For example, the memories Memory A, Memory B and Memory C may be discrete memory devices, such as DRAM, SRAM or flash chips, boards or modules. In other embodiments, the memories Memory A, Memory B and Memory C may be different types and have different performance and/or power efficiencies. For example, Memory A may be an onboard cache for, say the processor 15 or other integrated circuit, Memory B may be VRAM, and Memory C may be DRAM connected to the processor 15 by way of a bus or chip set. There are myriad possibilities for the number, location and type of memory for the memories Memory A, Memory B and Memory C and the connections related thereto. In addition, the computing device 10 may include a storage device 20, which may augment the data storage capabilities of the memories Memory A, Memory B and Memory C. The storage device 20 is a non-volatile computer readable medium and may be any kind of hard disk, optical storage disk, solid state storage device, ROM, RAM or virtually any other system for storing computer readable media. The connections between the components of the computing device 10 depicted as trace lines in FIG. 1 may be wired or wireless as desired.

The computing device 10 may include plural applications, which are abbreviated APP 1, APP 2 . . . APP n, and which may be drivers, software applications, or other types of applications. In addition, the computing device 10 may include an operating system 25. The operating system 25 and the applications APP 1 . . . APP n may be stored on the storage device 20. Windows®, Linux, or more application specific types of operating system software may be used or the like.

It should be understood that the computing device 10 may be any of a great variety of different types of computing devices that can conduct video processing. A non-exhaustive list of examples includes camcorders, digital cameras, personal computers, game consoles, video disk players such as Blue Ray, DVD or other formats, smart phones, tablet computers, graphics cards, system-on-chips or others. But various levels of device integration are envisioned. For example, the processor 15, Memory 1 and Memory 2 could be integrated into a single circuit card or integrated circuit, such as a CPU, a GPU, an APU, a system-on-chip or other.

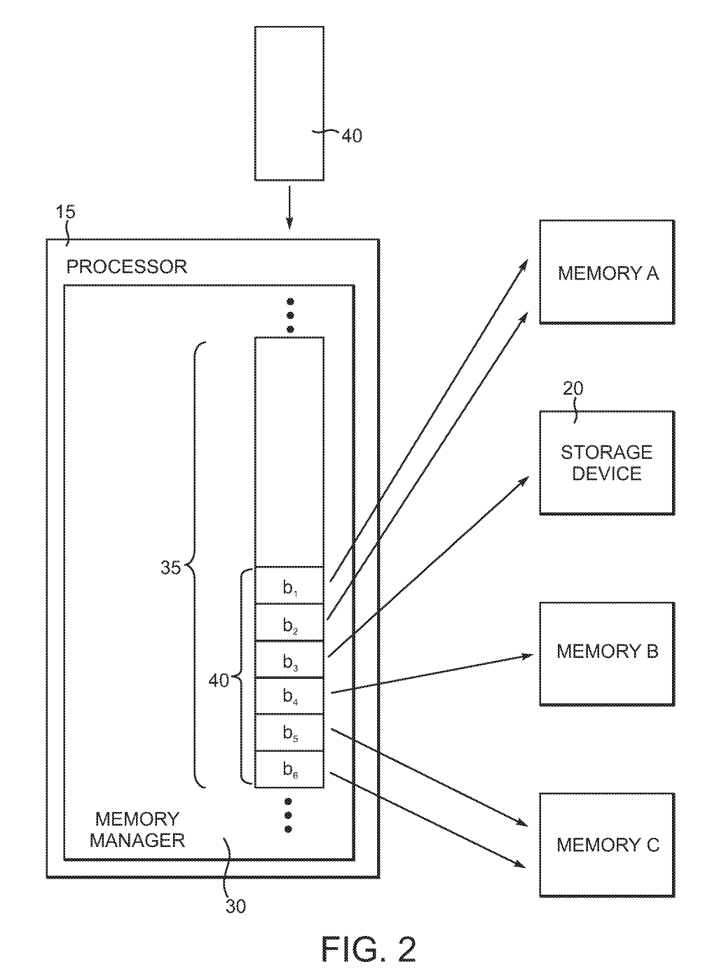

The processor 15 includes a memory manager 30 which is operable to, among other things, manage the flow of information to and from the memories Memory A, Memory B and Memory C and the storage device 20. As described in more detail below, the memory manager 30 is operable to maintain a virtual space and map blocks of information from the virtual space to the physical space associated with the memories Memory A, Memory B and Memory C and the storage device 20. In variations, the memory manager 30 may not be part of the processor 15 and may be implemented separate from and in communication with the processor 15 to accomplish the same functionality described herein. Additional details regarding the memory management functions of the memory manager 30 may be understood by referring now also to FIG. 2, which is a schematic view. Here, only the processor 15, the memories Memory A, Memory B and Memory C and the storage device 35 are depicted for simplicity of illustration. As noted briefly above, the memory manager 30 manages a virtual space 35. Here, the virtual space 35 is simplistically depicted schematically but it should be understood that the virtual space 35 may be quite large. This potentially large size of the virtual space 35 is represented schematically by the top and bottom ellipses. The virtual space 35 is operable to receive blocks of data and in this regard FIG. 2 depicts the virtual space 35 in possession of a data block 40 while an incoming data block is shown and labeled 40. The data block 40 may be placed in the virtual space 35 by way of a driver or one of the apps APP 1 . . . APP N or the OS 25 depicted in FIG. 1. Here it is assumed that the processor 15 has been instructed to store the data block 40 in a memory location. In this illustrative embodiment, the memory manager 30 is operable to split the allocation of the data block 40 into multiple standard size smaller sub-blocks b₁, b₂, b₃, b₄, b₅ and b₆ (collectively b₁ . . . b₆) where the number of the individual sub-blocks b₁ . . . b₆ here is simply illustrative. Each of the blocks b₁ . . . b₆ has a standard select size and this allocation of the data block 40 into the individual sub-blocks b₁ . . . b₆ is performed at the virtual side, that is in the virtual space 35 by the memory manager 30. The memory manager 30 is operable to then map the individual virtual blocks b₁ . . . b₆ to one or more potential storage locations such as Memory A storage device 20, Memory B and/or Memory C. Optionally, and as described in more detail below, all of the sub-blocks b₁ . . . b₆ may be allocated to one particular physical storage location. However, for illustration and discussion purposes, it is assumed in this illustrative embodiment that the memory manager 30 allocates the sub-blocks b₁ and b₂ to Memory A, the sub-block b₃ to storage device 20, the sub-block b₄ to Memory B and sub-blocks b₅ and b₆ to Memory C. In other words, the data block 40 is first split into multiple virtual sub-blocks b₁ . . . b₆ and then those virtual sub-blocks b₁ . . . b₆ may be mapped to multiple different types of memory, e.g., Memory A, Memory B, Memory C and the storage device 20. In this way, contiguous physical space does not have to be located for the entire data block 40. Physical space only has to be found for each of the sub-blocks b₁ . . . b₆. Furthermore, as described in more detail below, certain sub-blocks may be high value allocations, that is, those sub-blocks that either require or will benefit from being assigned to one memory that is more efficient than another. For example, Memory A may be a most performance efficient kind of memory associated with a computing device 10 and therefore it may make performance sense to allocate sub-blocks b₁ and b₂ to Memory A while sub-block b₃ may be a lower priority sub-block that may be allocated to the physical space associated with the storage device 20 without significant performance penalty and so on and so forth for the other sub-blocks b₄, b₅ and b₆. The same preferential allocation approach can be applied to power efficiencies. For example, where power consumption must be constrained, preferential allocations can be made to more or less power efficient kinds of memory. Power efficiency of physical memory blocks or storage devices may come in several varieties. Two examples are semiconductor or other manufacturing technology based (smaller low power transistors, etc.) or actual system board layout wire length based (where distance defines the capacity of wires and required power to drive them). Both examples can be used in memory manager optimization separately or combined.

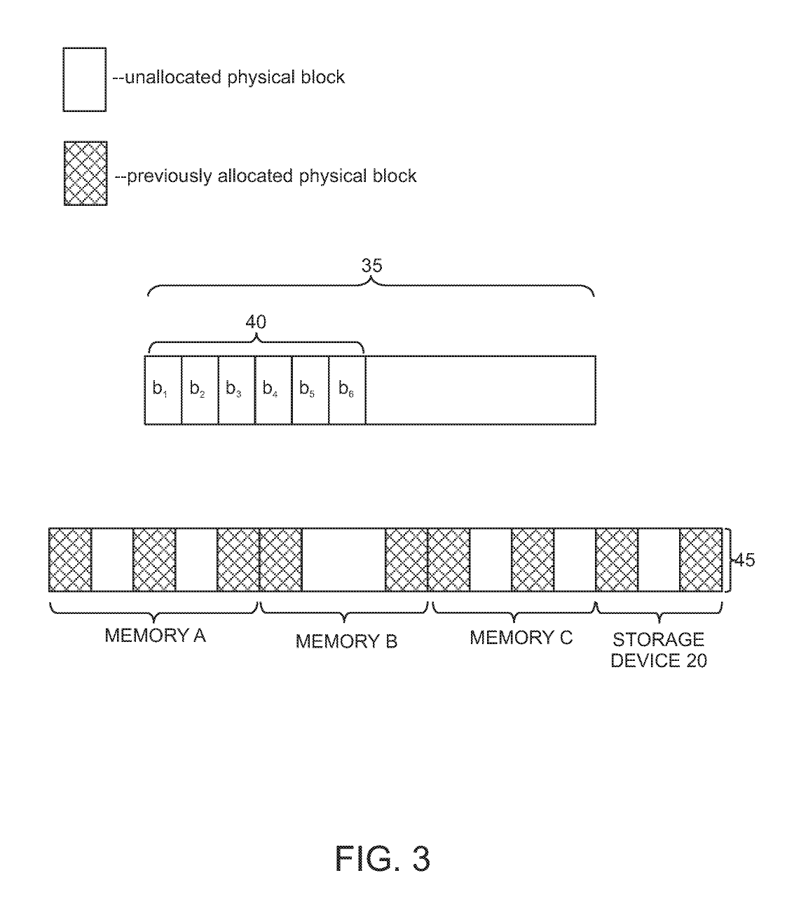

Additional details of exemplary allocation and deallocation of data blocks may be understood by referring now to FIG. 3, which is a schematic view. Here, the aforementioned virtual space 35 is schematically depicted and rotated 90° from its position shown in FIG. 2. Again, the data block 40 is depicted consisting of the split allocation of virtual sub-blocks b₁ . . . b₆. Below the virtual space 35 is depicted a physical memory space 45, which consists of the individual physical spaces associated with Memory A, Memory B, memory C and the storage device 20. The skilled artisan will appreciate that the physical space 45 need not consist of the memories Memory A, Memory B and Memory C and the storage device 20, but may instead consist only of a single memory device or some other configuration as desired. Here, it is assumed that the physical space 45 has been operated for some period of time and includes previously allocated physical blocks indicated by the mesh rectangles. Unallocated physical blocks are represented by the white rectangles. Note that the data block 40, if not sub-allocated into the multiple smaller blocks b₁ . . . b₆, could not be mapped to any of the currently available unallocated physical blocks in the physical space 45 and thus would have to be stored somewhere to the right of the unallocated physical blocks and thus lead to a potential memory fragmentation situation.

An exemplary mapping and thus allocation of the sub-blocks b₁ . . . b₆ of the data block 40 of the virtual space 35 may be understood by referring to FIGS. 2, 3 and 4. Here, the sub-blocks b₁ and b₂ are allocated or mapped to the previously unallocated physical blocks in Memory A to establish newly allocated physical blocks, the sub-blocks b₃ and b₄ are allocated to the previously unallocated physical blocks in Memory B and the sub-blocks b₅ and b₆ are allocated to the previously unallocated physical blocks in Memory C. The unallocated physical block in the storage device 20 remains unallocated. Note that the sub-blocks b₁ . . . b₆ may be allocated to the physical space 45 in non-contiguous blocks with the exception of the illustrated contiguous blocks in Memory B. However, it should be understood that the virtual mapping and addressing capabilities of the memory manager 30 shown in FIG. 2 are such that all of the sub-blocks b₁ . . . b₆ may be allocated to non-contiguous blocks and of course into disparate memory locations. The memory manager 30 may make physical allocation decisions in a variety of ways and based on a variety of factors. For example, the memory manager 30 may operate in one or more memory mapping efficiency modes, such as a performance efficiency mode or a power efficiency mode. These modes may be manually or automatically selected. In performance efficiency mode, the physical allocations of some or all of the sub-blocks b₁ . . . b₆ are made to the most or more performance efficient memory locations. Entry, operation in and exit from performance efficiency mode may be dictated by user input, instructions from an application or driver, internal code of the memory manager 30 or heuristics analysis performed by the memory manager 30. For example, the memory manager 30 may sense certain characteristics of an incoming data block 40 and take certain actions. The characteristics of the data block 40 may be supplied by an application or driver or may be recognized by way on memory manager 30 internal code or by memory manager 30 heuristics. The action taken may be entry into performance efficiency mode, continued operation in performance efficiency mode or exit from performance efficiency mode. For example, the data block 40 may be accompanied by a driver instruction that identifies the data block 40 as high value and calls for entry into or continued operation in performance efficiency mode. The split sub-blocks b₁ . . . b₆ of the data block 40 may then be mapped to the most or more performance efficient physical blocks of Memory A, Memory B etc. The performance efficiency may be memory speed, shortest pathway to memory or other. In another example, the memory manager 30 may, based on its own internal code and/or heuristics analysis of previous data blocks, assess whether to operate in performance efficiency mode and how to make the corresponding mappings. The next data block may trigger continued operation in or exit from performance efficiency mode. The same techniques in terms of entry, operation and exit, can be applied to power efficiency mode. In power efficiency mode, the memory manager 30 attempts to make physical allocations to reduce or minimize power consumption. Here, the decision to enter, operate in and exit from power efficiency mode may again be based on application or driver instructions, operating system instructions and/or the characteristics of the data block 40. If the memory manager 30 enters or is operating in power efficiency mode, then the split sub-blocks b₁ . . . b₆ of the data block 40 may then be mapped to the most or more power efficient physical blocks of Memory A, Memory B etc.

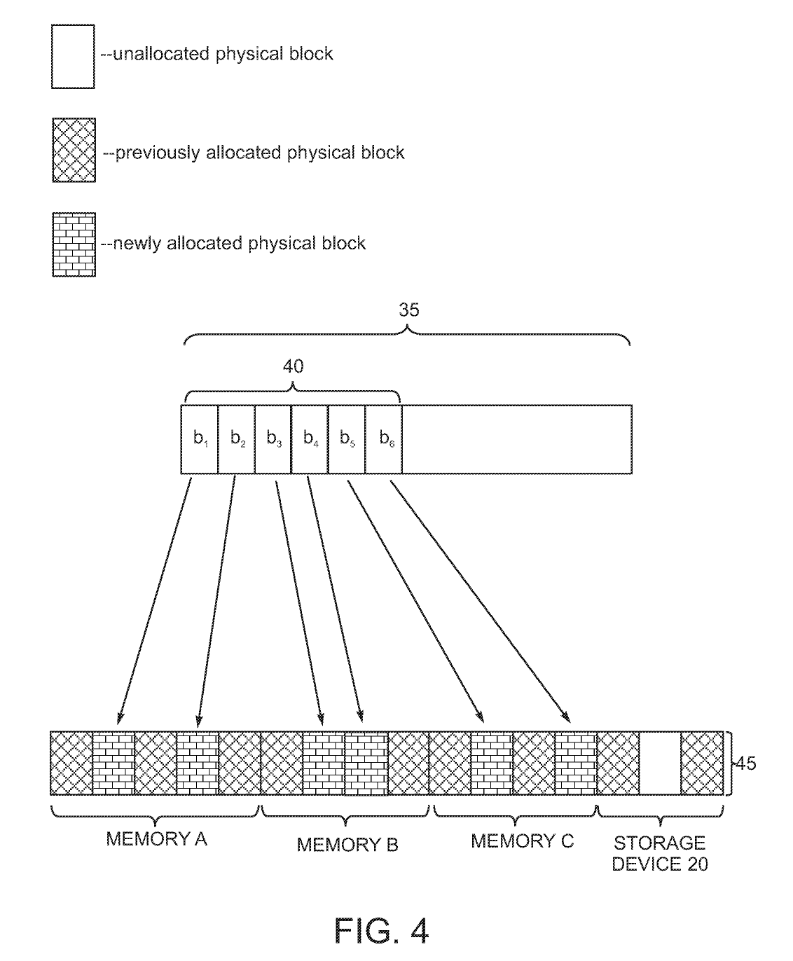

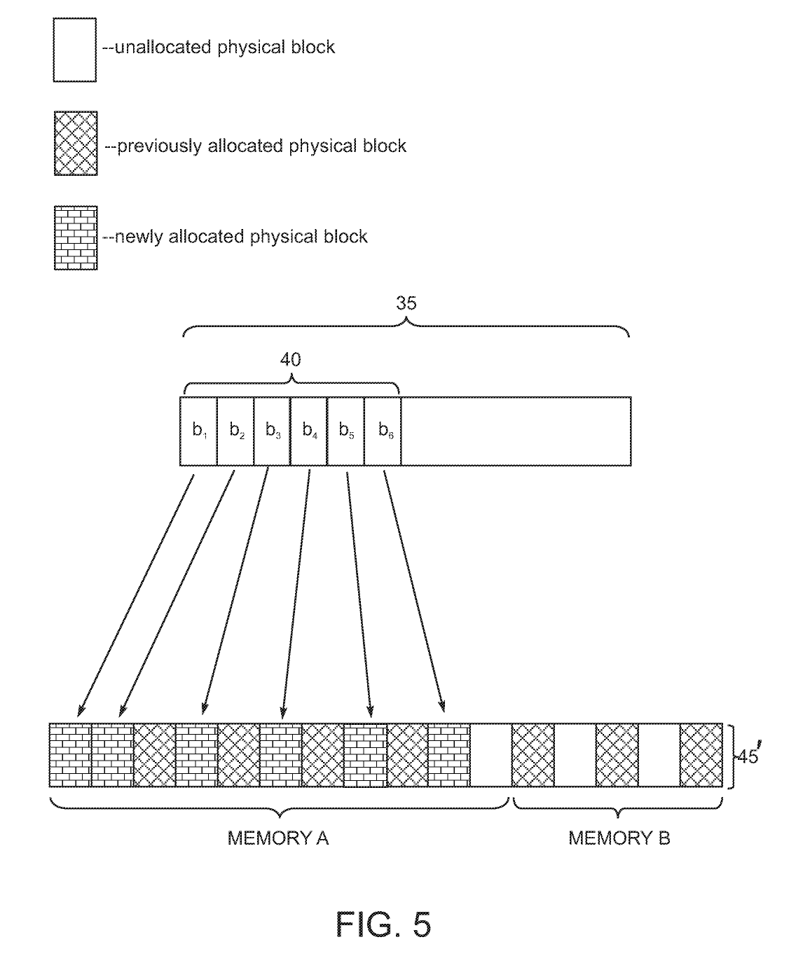

As noted above, allocations to a physical memory space may be to non-contiguous space and multiple memory devices or within a single memory device. In this regard, attention is now turned to FIG. 5, which is a schematic view like FIG. 4 but depicts an alternate exemplary physical memory space 45′ that includes Memory A and Memory B. The data block 40 of the virtual space 35 may again be sub-divided into sub-blocks b₁ . . . b₆. The sub-blocks b₁ . . . b₆ may all be allocated to Memory A with some or all of the newly allocated physical blocks being contiguous or non-contiguous. Thus, sub-blocks b₃, b₄, b₅ and b₆ may be allocated to non-contiguous newly allocated physical blocks while sub-blocks b₁ and b₂ may be contiguous. Again, it should be understood that the sub-blocks b₁ . . . b₆ may all be contiguously allocated in the physical space 45′ or none of them need be contiguous.

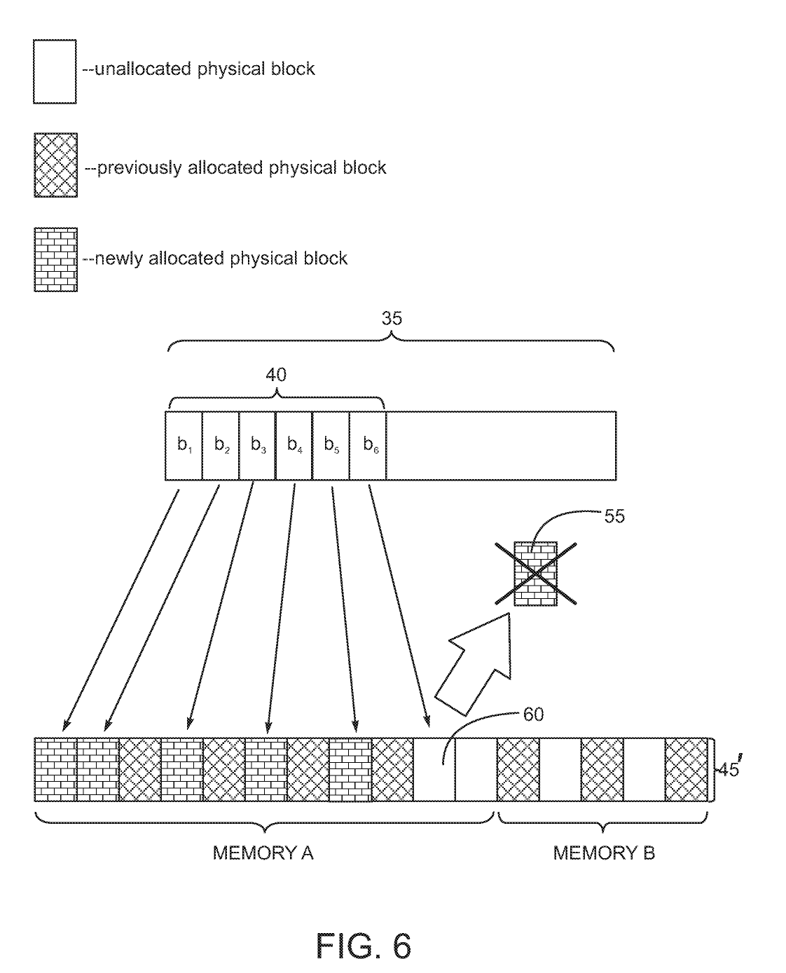

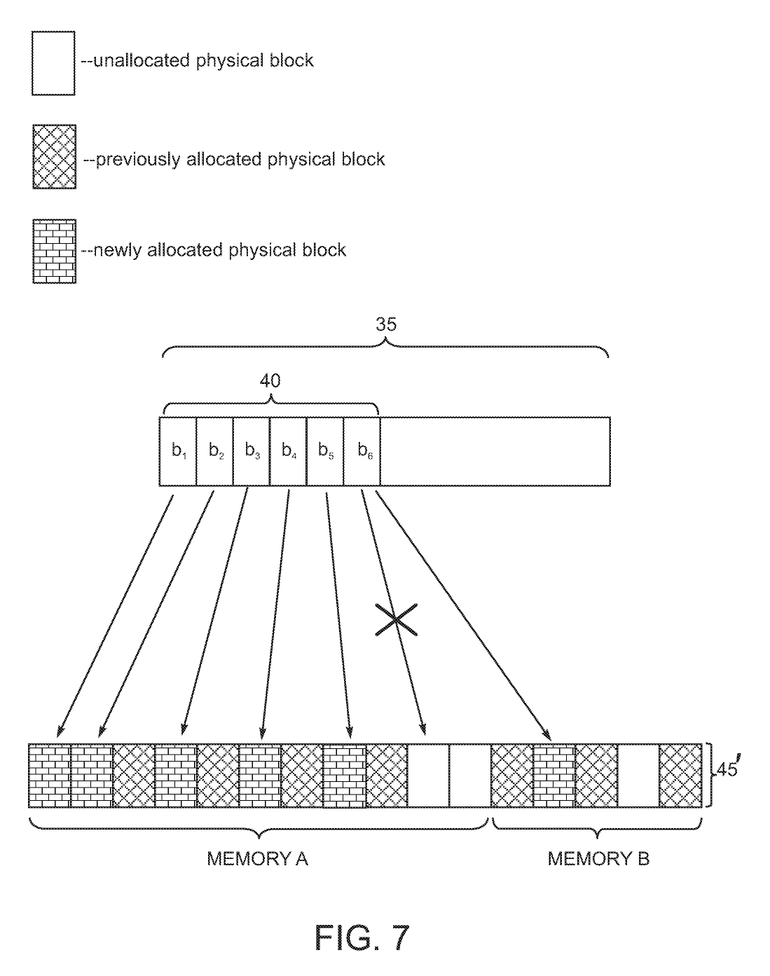

The allocation and deallocation of the physical space 45′ is a dynamic process. In this regard, attention is now turned to FIG. 6, which is a schematic view like FIG. 5. Here, the sub-blocks b₁ . . . b₆ of the data block 40 of the virtual space 35 were initially mapped to newly allocated physical blocks of Memory A. However, the formerly newly allocated physical block 55 has been deallocated to produce an unallocated physical block 60 of Memory A. Since the virtual allocation of the data block 40 into the sub-blocks b₁ . . . b₆ of a standard size has been performed and ongoing, the newly unallocated physical block 60 may be readily reallocated with another sub-block from another data block, such as for example the data block 40 shown in FIG. 2, or it may be possible to deallocate the physical block 55 to produce the unallocated physical block 60 and then, for example, reallocate the physical block 55 to an unallocated physical block somewhere else in the physical space 45′. This change in priority or re-mapping for a sub-block may be understood by referring now also to FIG. 7, which is a schematic view like FIG. 6. Here, the sub-blocks b₁ . . . b₆ of the data block 40 of the virtual space 35 have been initially allocated to the newly allocated physical blocks of Memory A of the physical space 45′. However, the memory manager 30 depicted in FIG. 2 may subsequently determine that it is appropriate to change the mapping of a sub-block, for example sub-block b₆, from a physical block in Memory A and remap that sub-block b₆ to an unallocated physical block in Memory B. This might occur for a variety of reasons. For example, the memory manager 30 may rank the sub-blocks b₁ . . . b₆ based on their respective computational intensities and determine that the sub-block b₆ does not require the most efficient memory, such as Memory A, and may be reallocated to Memory B without penalizing computing performance and/or power performance. The impetus to make this reallocation may occur where, for example, a new resource or part of a new resource, such as the data block 40 (see FIG. 2) may call for allocation to the most performance or power efficient memory associated with the computing device 10 and therefore it may be appropriate to reallocate and thus reprioritize one or more of the sub-blocks b₁ . . . b₆ and in this case b₆. This may be done for more than simply one of the sub-blocks of the data block 40.

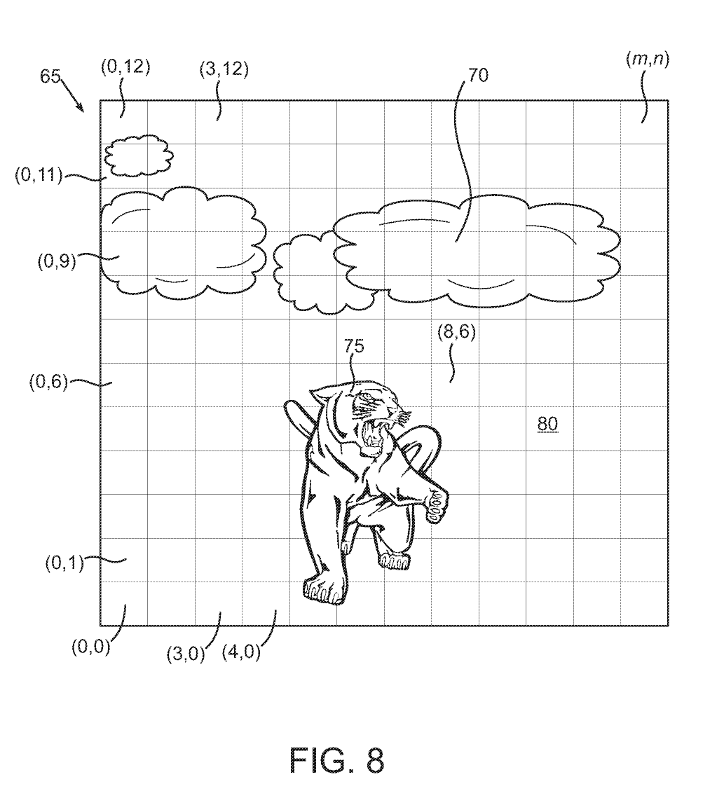

As just noted, there may be a variety of circumstances where the priority of sub-blocks may be adjusted in order to accommodate various changes and requirements in the computing environment. For example, FIG. 8 depicts a single video frame 65 of a relatively simplified nature scape that includes a few clouds 70 and a big cat 75 that are in front of an otherwise pale background 80. As shown in FIG. 8, the video frame 65 consists of an array of pixels (0,0) to (m, n) where m represents the video frame width and n represents the video frame height. In this simple illustration, the pixel array (0,0) to (m, n) numbers only one hundred and forty-four pixels. However, the skilled artisan will appreciate that video displays may include much larger numbers of pixels. In this simple illustration, the clouds 70 are relatively static from frame to frame but the big cat 75 is actively moving about and thus is changing shape, size and location from frame refresh to frame refresh. The portion of the frame 65 associated with the location of the cat 75 may encompass some range of pixels, in this illustration, say pixels (4,0) to (8,6) while the more static features occupy different ranges of pixels. Now assume for the purposes of this illustration that the frame 65 is a resource that corresponds to the data block 40 depicted in FIG. 7. The memory manager 30 shown in FIG. 2 may sub-divide the data block 40 (the frame 65) into the aforementioned virtual sub-blocks b₁ . . . b₆. But for mapping to physical space 45′, the memory manager 30 may rank the sub-blocks b₁ . . . b₆ based on their respective computation intensity and determine that some parts of the video frame 65 are less important than others. For example, the clouds 70 may be relatively unchanging or otherwise require less data and computing resources in order to be properly displayed or rendered while the cat 75 may be rapidly moving or otherwise changing and thus require a greater priority of more efficient memory. For example, and referring again to FIG. 8, the sub-blocks that correspond to just the portion of the frame 65 that includes rapidly changing features, such as the cat 75, may be allocated to the most efficient memory Memory A, e.g., sub-blocks b₁ and b₂ would be mapped to Memory A. The sub-blocks, say sub-blocks b₃ . . . b₆, that correspond to those features of the data block 40 (the frame 65) that remain relatively static from frame to frame, such as the clouds 70 and the pale background 80, may be mapped to a less efficient physical space, such as Memory B (or Memory C and/or the storage device 20 in FIG. 2). Reallocation may also play a role. For example, some or all of the sub-blocks b₃ . . . b₆ may also be initially mapped to Memory A, but thereafter reallocated to less efficient memory B. This allocation and reallocation and prioritization may occur with each successive video frame, data block or other subdivision of a resource(s).

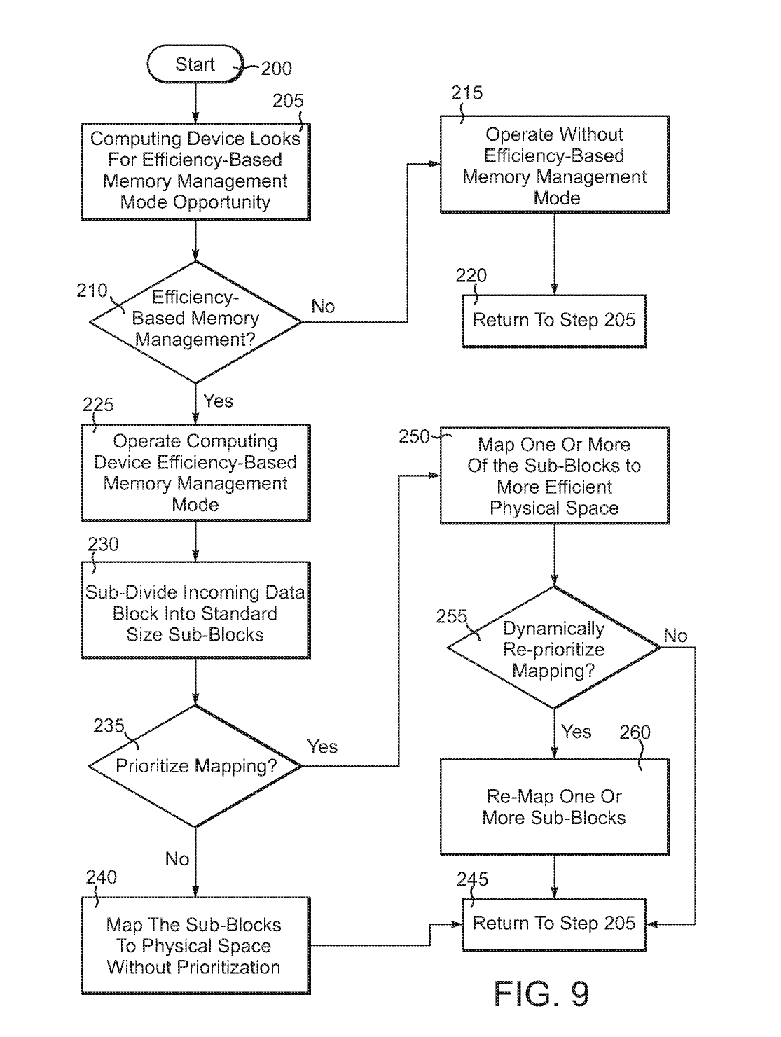

An exemplary process flow for operation of the computing device 10 may be understood by referring now to FIG. 1 and to the flow chart depicted in FIG. 9. The operation of the computing device 10 utilizing the memory mapping schemes disclosed herein may be termed efficiency-based memory management mode. It should be understood that the operation of the processor 15 and the memory manager 30 in efficiency-based memory management mode is optional. Thus, after start at step 200, the computing device 10 may look for an efficiency-based memory management mode opportunity at step 205. As noted above, this decision making may be governed by the operating system 25, by one or more of the applications/drivers APP 1 . . . APP N, by internal code of and/or heuristic analysis by the memory manager 30 and/or by other factors. Furthermore, the decision to whether or not to enter into efficiency-based memory management mode may be based on power requirements or even a manual selection by a user if that opportunity is presented by the computing device 10. At step 210, if an opportunity for efficiency-based memory management mode is not seen, the process proceeds to step 215 and memory management is performed in a mode other than efficiency-based and at step 220, the process then returns to step 205. If, on the other hand at step 210, an opportunity for efficiency-based memory management is detected, then at step 225 the memory manager 30 operates in efficiency-based memory management mode. At step 230, the memory manager 30 subdivides an incoming resource or data block 40 into plural sub-blocks of standard size, e.g., sub-blocks b₁ . . . b₆ (see FIG. 2). At step 235, the memory manager 30 makes a determination about prioritized mapping. Here, the memory manager 30 searches for available physical space for the sub-blocks b₁ . . . b₆. If physical space is available for all of the sub-blocks b₁ . . . b₆, then prioritization is not necessary and the sub-blocks b₁ . . . b₆ may all be mapped to more or most efficient memory (physical space) at step 240 without prioritization. This may correspond to the mapping of, for example, the sub-blocks b₁ . . . b₆ to contiguous and/or noncontiguous space in one or more memory locations, such as Memory A, Memory B, Memory C and/or the storage device 20, depicted in FIGS. 2-7 and described elsewhere herein. Mapping is followed by a return to step 205 via step 245. If, however, physical space cannot be found for all the sub-blocks b₁ . . . b₆, then prioritization mapping is performed at step 240 and at step 250 one or more of the sub-blocks is mapped to more efficient physical space. Again, this entails mapping of, for example, one or more of the sub-blocks b₁ . . . b₆ to contiguous and/or noncontiguous space in one or more relatively more efficient memory locations, such as Memory A, Memory B, Memory C and/or the storage device 20, depicted in FIGS. 2-7 and described elsewhere herein. At step 255, the memory manager 30 makes a determination about dynamically re-prioritizing mapping. Here, the memory manager 30 checks for opportunities to re-map one or more of the sub-blocks b₁ . . . b₆. An example of this is described above in conjunction with FIGS. 7 and 8, where the sub-blocks b₁ . . . b₆ have been ranked according to computational intensity by the memory manager 30 and based on that ranking sub-block b₆ is deallocated from a physical block in Memory A and reallocated to a physical block in Memory B. If no re-mapping opportunity is detected, then the process proceeds to step 245 and ultimately step 205. If a remapping opportunity is detected at step 255, then at step 260 one or more sub-blocks b₁ . . . b₆ are re-mapped followed by step 245 and a return to step 205.

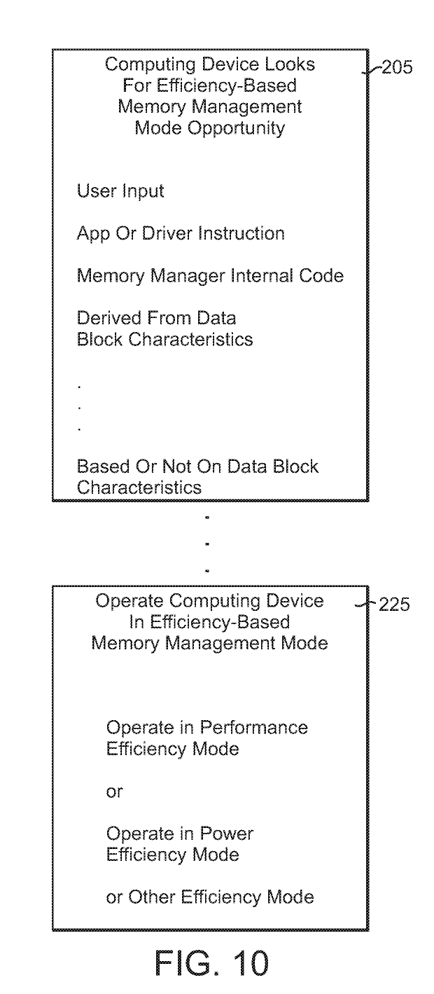

A more detailed exemplary depiction of steps 205 and 225 is provided in FIG. 10. As noted above, step 205 may entail the computing device 10 looking at user input, an app or driver instruction, memory manager internal code, memory manager derived data block characteristics or other input for an impetus to enter or continue operation in an efficiency-based memory management mode, such as performance efficiency, power efficiency or other. The impetus to enter or continue operation in an efficiency mode may be based on the sensed or otherwise provided characteristics of an incoming data block or not for the other than derived characteristics. At step 225, the computing device is operated in an efficiency-based mode, such as performance efficiency, power efficiency or other. Thus, the entry, operation and exit may be manually-dictated or automated.

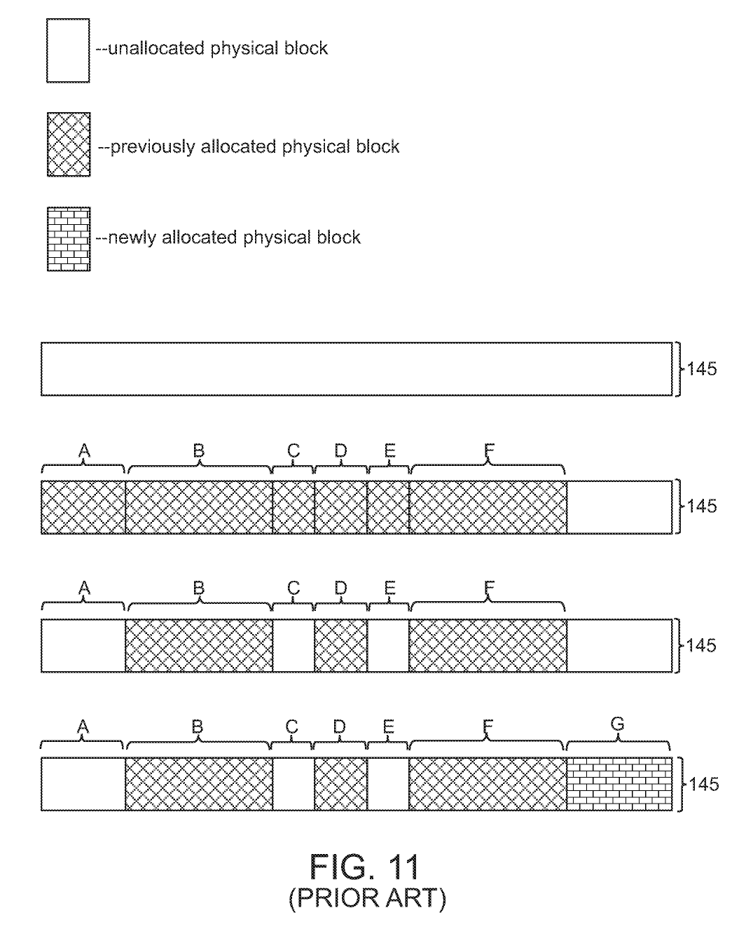

It may be useful at this point to briefly contrast a conventional memory allocation scheme which is depicted schematically in FIG. 11. Here, it is assumed that a physical space 345 initially consists of all unallocated physical blocks. After some period of operation, plural physical blocks A, B, C, D, E and F are allocated in the physical space 345. The physical blocks A . . . F are of varying sizes. Subsequently, physical block A, physical block C and physical block E have been deallocated and thus freed up. Finally, a new allocation is made of a block G that is too big to be allocated to the deallocated physical blocks A, C or E and thus must be allocated at the end, leaving the physical blocks A, C and E open and thus creating the beginnings of a memory fragmentation situation.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of memory management, comprising:
receiving a data block in a virtual space;
sub-dividing the data block into plural sub-blocks of the same size; and
mapping the plural sub-blocks to a physical space according to a selected memory mapping efficiency mode.

2. The method of claim 1, wherein the mapping comprises mapping the each of the plural sub-blocks to non-contiguous portions of the physical space.

3. The method of claim 1, wherein the mapping comprises mapping a portion of the sub-blocks to non-contiguous portions of the physical space and another portion of the sub-blocks to contiguous portions of the physical space.

4. The method of claim 1, wherein the physical space includes a first memory and a second memory, the first memory having more efficient performance than the second memory, the mapping comprising searching the first memory and the second memory for available space for the sub-blocks and mapping all the sub-blocks to the first memory if the first memory is found to contain sufficient space or mapping some of the sub-blocks to the first memory and others of the sub-blocks to the second memory if the first memory is found not to contain sufficient space.

5. The method of claim 4, comprising re-mapping a sub-block from the first memory to the second memory.

6. The method of claim 4, comprising ranking the sub-blocks based on a computational intensity associated with each sub-block, and mapping higher computational intensity sub-blocks to the first memory and lower computational intensity sub-blocks to the second memory.

7. The method of claim 6, comprising re-mapping a sub-block if the computational intensity of that sub-block changes.

8. A method of operating a computing device, comprising:
receiving a data block in a virtual space of a processor memory manager;
sub-dividing the data block into plural sub-blocks of the same size with the memory manager; and
mapping the plural sub-blocks to a physical space with the memory manager, the physical space including a first memory and a second memory, the mapping according to a selected memory mapping efficiency mode.

9. The method of claim 8, wherein the mapping comprises mapping the each of the plural sub-blocks to non-contiguous portions of the physical space.

10. The method of claim 8, wherein the mapping comprises mapping a portion of the sub-blocks to non-contiguous portions of the physical space and another portion of the sub-blocks to contiguous portions of the physical space.

11. The method of claim 8, wherein the first memory having more efficient performance than the second memory, the mapping comprising searching the first memory and the second memory for available space for the sub-blocks and mapping all the sub-blocks to the first memory if the first memory is found to contain sufficient space or mapping some of the sub-blocks to the first memory and others of the sub-blocks to the second memory if the first memory is found not to contain sufficient space.

12. The method of claim 11, comprising re-mapping a sub-block from the first memory to the second memory.

13. The method of claim 11, comprising ranking the sub-blocks based on a computational intensity associated with each sub-block, and mapping higher computational intensity sub-blocks to the first memory and lower computational intensity sub-blocks to the second memory.

14. The method of claim 13, comprising re-mapping a sub-block if the computational intensity of that sub-block changes.

15. A computing device, comprising:
a memory manager;
a physical space having a first memory and a second memory; and
wherein the memory manager includes a virtual space and is operable to receive a data block in a virtual space of a processor memory manager, sub-divide the data block into plural sub-blocks of the same size, and map the plural sub-blocks to the physical space according to a selected memory mapping efficiency mode.

16. The computing device of claim 15, wherein the memory manager comprises part of a processor.

17. The computing device of claim 15, wherein the first memory and the second memory comprise different memory types.

18. The computing device of claim 17, wherein the first memory has a more efficient performance than the second memory.

19. The computing device of claim 18, wherein the mapping comprises searching the first memory and the second memory for available space for the sub-blocks and mapping all the sub-blocks to the first memory if the first memory is found to contain sufficient space or mapping some of the sub-blocks to the first memory and others of the sub-blocks to the second memory if the first memory is found not to contain sufficient space.

20. The computing device of claim 18, wherein the memory manager is operable to re-mapping a sub-block from the first memory to the second memory.

21. The computing device of claim 18, wherein the memory manager is operable to rank the sub-blocks based on a computational intensity associated with each sub-block, and map higher computational intensity sub-blocks to the first memory and lower computational intensity sub-blocks to the second memory.

22. The computing device of claim 21, wherein the memory manager is operable to re-map a sub-block if the computational intensity of that sub-block changes.
